(19) United States
(12) Patent Application Publication
(10) Pub. No.: US 2010/0165373 A1
(43) Pub. Date: Jul. 1, 2010

(54) INFORMATION PROCESSING APPARATUS, INFORMATION PROCESSING METHOD, AND INFORMATION PROCESSING PROGRAM STORAGE MEDIUM

(75) Inventor: Shiori Arai, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/543,764

(22) Filed: Aug. 19, 2009

(30) Foreign Application Priority Data
Dec. 26, 2008 (JP) 2008-334899

(51) Int. Cl. G06F 15/00

(52) U.S. Cl. 358/1.13

(57) ABSTRACT

An image processing apparatus having plural information processing functions includes a storage unit, a specification unit a function specifying unit, a setting unit, and an execution unit. The storage unit stores at least one execution condition in which plural setting items for the plural information processing functions, and setting values for the respective setting items, are associated with one another. The specification unit specifies any one of the execution condition. The function specifying unit specifies an information processing function. The setting unit sets the setting values of at least one setting item of the specified execution condition, which setting item can be set in the specified information processing function, as the setting values of a corresponding at least one setting item of the specified information processing function. The execution unit executes the specified information processing function based on the set setting values.

### CROSS-REFERENCE TO RELATED APPLICATIONS

This application is based on and claims priority under 35 USC 119 from Japanese Patent Application No. 2008-334899 filed on Dec. 26, 2008.

### BACKGROUND

1. Technical Field

The present invention relates to an information processing apparatus, an information processing method, and a storage medium storing an information processing program.

2. Related Art

In an image processing apparatus having plural information processing functions for images, such as a copy function, an image reading function, and a facsimile communication function (hereinafter, each referred to as image processing function), settings for the image processing function and various processing items in the image processing function are specified, and based on this setting, image processing is performed.

In such image processing apparatus, there is proposed a configuration in which image processing functions and setting values (parameters) of various processing items for each of the image processing functions are set in advance, processing based on each of the processing functions and the various parameters for the processing function can be performed by reading out the setting of the corresponding parameters.

### SUMMARY

An aspect of the invention is an image processing apparatus having plural information processing functions, the apparatus including: a storage unit that stores at least one execution condition in which plural setting items set for execution of the plural information processing functions, and setting values for the respective setting items, are associated with one another; a specification unit that specifies any one of the at least one execution condition; a function specifying unit that specifies an information processing function to be executed from among the plural information processing functions; a setting unit that sets the setting values of at least one setting item of the specified execution condition, which setting item can be set in the specified information processing function, as the setting values of a corresponding at least one setting item of the specified information processing function; and an execution unit that executes the specified information processing function based on the set setting values.

### BRIEF DESCRIPTION OF THE DRAWINGS

Exemplary embodiments of the present invention will be described in detail based on the following figures, wherein:

FIG. 1 is a perspective view showing a general structure of a multifunction device according to exemplary embodiment;

FIG. 2 is a configuration diagram showing a main configuration of a controller provided in the multifunction device;

FIG. 3 is a chart showing a part of setting values for each information processing functions;

FIG. 4 is a diagram showing one example of a display screen used for specification of a job memory in a first exemplary embodiment;

FIG. 5A is a diagram showing one example of a main menu screen, FIG. 5B is a diagram showing one example of an operation screen for a scanner mode in which initial values are set as the setting values, and FIG. 5C is a diagram showing one example of an operation screen for the scanner mode in which setting values of a job memory are set as the setting values through FIG. 5B;

FIG. 6 is a flowchart showing one example of an image processing according to the first exemplary embodiment;

FIGS. 7A to 7C are diagrams each showing an example of a confirmation screen;

FIG. 8 is a flowchart showing one example of an image processing according to a second exemplary embodiment;

FIG. 9A is a diagram showing one example of a menu screen used for reading job memories, and FIG. 9B is a diagram showing one example of a display screen used for specification of a job memory;

FIGS. 10A and 10B are diagrams each showing an example of a confirmation screen; and

FIG. 11 is a diagram showing one example of an operation screen in a facsimile mode in which setting values of a job memory are set as the setting values.

### DETAILED DESCRIPTION

Exemplary embodiments are described below in reference to the attached drawings.

### First Exemplary Embodiment

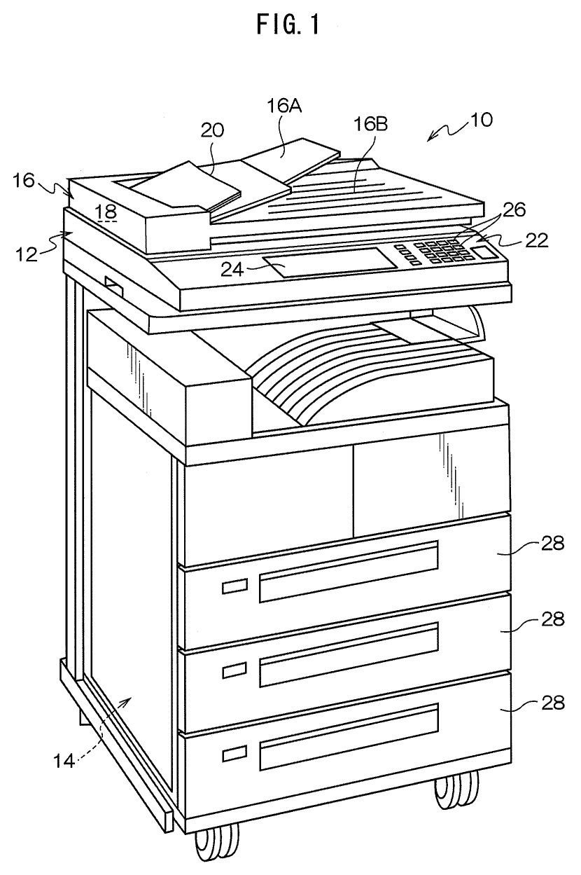

In the exemplary embodiments, a multifunction device 10 is used as an information processing apparatus. In FIG. 1, the multifunction device 10 is shown. The multifunction device 10 has plural information processing functions including a printing function of receiving data inputted through a communication network such as a network and forming an image on an image formation medium such as recording sheet based on the received data, a copy function of forming on a recording sheet an image recorded on an original, a scanner function of reading an image recorded on an original and generating data of the read image, a facsimile function of reading an image recorded on an original and transmitting the read image data through communication means such as a telephone line, and the like. Namely, the multifunction device 10 has the copy function, the scanner function, and the facsimile function as information processing functions that may perform image processings based on user operations.

In the multifunction device 10, a reading unit 12 is provided in an upper portion of the device, and an image formation unit 14 is arranged below the reading unit 12. The reading unit 12 has a conveyance unit 18 inside a cover 16. The conveyance unit 18 pulls in an original 20 loaded on a feeder tray 16A provided in the cover 16 in sequence and conveys the original 20 onto a platen glass which is not shown. The reading unit 12 reads an image recorded on the original 20 conveyed on the platen glass, and generates image data corresponding to the image. The conveyance unit 18 discharges, onto a discharge tray 16B, the original 20 after the reading of the image thereof has completed.

The reading unit 12 is provided with a user interface 22, which enables various operation inputs by a user. The user interface 22 includes a touch-panel-type display 24 on which various types of information are displayed and display buttons that realizes input of information by a software program are displayed, and hardware keys 26 such as ten keys and a start key. In the user interface 22, various types of information, for example, a scale factor when the copy function is used, a telephone number of a communication destination when the facsimile function is used, and the like are inputted by the display buttons of the display 24 and the hardware keys 26, and the inputted information is received by the multifunction device 10.

The image formation unit 14 has a sheet feeding tray 28 in which recording sheets used as an image formation medium are contained. The image formation unit 14 takes out the recording sheets one by one from the sheet feeding tray 28, and forms images in accordance with the image data by, for example, an electrophotographic process while conveying the recording sheet. The image formation unit 14 discharges the recording sheet after the image formation has completed onto a sheet discharge tray which is not shown.

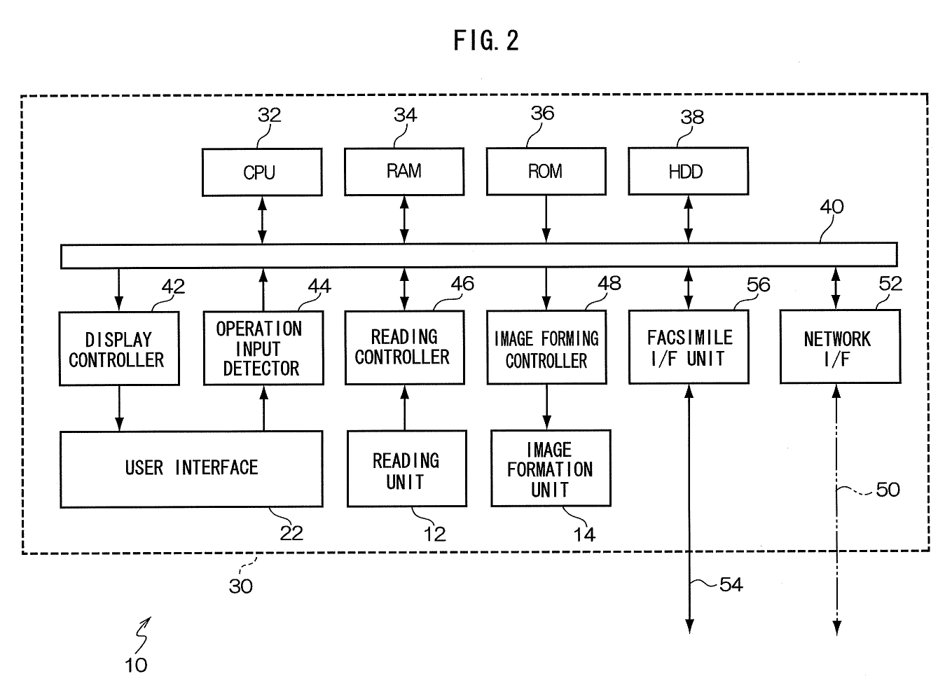

In FIG. 2, a main configuration of a controller 30 provided in the multifunction device 10 is shown. The controller 30 of the multifunction device 10 includes a Central Processing Unit (CPU) 32 that controls overall operations of the device, a Random Access Memory (RAM) 34 in which various types of data are temporarily stored, a Read Only Memory (ROM) 36 in which various types of programs and data including a control program for controlling the overall device operations are stored, and an Hard Disk Drive (HDD) 38 in which various types of data and programs are stored. These components are connected through a bus 40 such as a system bus and form a computer with a general configuration.

Various programs executed in the CPU 32, data used in the processing in the CPU 32 and the like may be stored in the ROM 36 or the HDD 38, or may be received from outside of the device through a communication network or a communication line as data signals, or may be provided in a state in which they are stored in a computer-readable storage medium such as a DVD-ROM.

The controller 30 has a display controller 42 that is connected to the user interface 22, and controls display of various types of information and operation screens on the display 24 of the user interface 22, and an operation input detector 44 that is connected to the user interface 22, and detects an operation instruction inputted as an operation on the display 24 or the hardware keys 26. These components are also connected to the bus 40.

The controller 30 further has a reading controller 46 that controls optical reading operation of an image by the reading unit 12 and original feeding operation by the conveyance unit 18, and an image forming controller 48 that controls the image formation processing by the image formation unit 14. Further, the controller 30 has a network interface (network I/F) unit 52 that is connected to a network (communication network) 50 and transmits and receives communication data with an image processing terminal connected to the network 50, and a facsimile interface (facsimile I/F) unit 56 that is connected to a communication line 54 such as a telephone line and transmits and receives facsimile data with another facsimile apparatus having the facsimile function, which is connected to the communication line 54.

The controller 30 performs display of the operation screens on the display 24 of the user interface 22 and display control on information such as various messages through the display controller 42, operation control of the reading unit 12 including the conveyance unit 18 through the reading controller 46, operation control of the image formation unit 14 through the image forming controller 48, control on the transmission and reception of communication data through the network interface unit 52, and control on the transmission and reception of facsimile data through the facsimile interface unit 56. Further, the CPU in the controller 30 grasps operations performed at the user interface 22 based on operation information detected by the operation input detector 44 and performs various types of control based on these operations.

In the multifunction device 10 configured as described above, a menu image (screen) including a copy button for selecting the copy function, a scanner button for selecting the scanner function, and a fax button for selecting the facsimile function is displayed on the display 24, and upon detection of any one of these buttons has been operated at the menu screen, the information processing function in accordance with the detected button operation is executed.

For example, upon detection of an operation of the copy button, the multifunction device 10 shifts to a copy mode, in which the copy function is performed. At this time, the controller 30 displays an operation screen for the copy mode on the display 24, and a user may perform on this operation screen setting of setting values (hereinafter, referred to as setting of parameters) for various setting items, such as a number of sheets to be copied, a scale factor, a size of the recording sheet, selection between color mode and monochrome mode, and the like. Thereafter, when the controller 30 detects an operation of a start button, an image recorded on the original 20 is read and the read image is formed on a recording sheet.

On the other hand, when the controller 30 detects that the fax button has been operated, the device shifts to a facsimile mode, in which the facsimile function (facsimile transmission) is performed, and when the controller 30 detects that the scanner button has been operated, the device shifts to a scanner mode. For performing the image processing in the copy mode, the facsimile mode and the scanner mode in the multifunction device 10, known configurations may be adopted.

In the multifunction device 10, the information processing functions and the parameters (setting values) of various setting items for the information processing functions may be set in advance, and this lump setting information may be stored as an execution condition in the storage medium such as the HDD 38 based on an instruction of the user. Hereinafter, a description is given on the premise that combinations of the plural setting items and the corresponding setting values, which are set in order to perform a processing using these information processing functions, are stored as an execution condition. In the execution condition, an information processing functions (processing modes) selected from the copy function (copy mode), the facsimile function (facsimile mode), or the scanner function (scanner mode), and parameters (setting values) of the setting items applied to the information processing functions are set. A function of registering such execution condition as a set of the plural setting items and the corresponding setting values for reusing may be referred to as “job memory”. Also, the registered one or more execution conditions (information) themselves may be referred to as “job memories”.

That is, the user may input or set the setting values of the setting items required to be set for performing any one of the plural information processing functions. When the setting values are inputted for the plural setting items, and if the user wishes to reuse the same setting later, the execution condition which is a combination of the plural setting items and the corresponding setting values of the respective setting items is stored in the HDD 38 or other storage unit. At this time, not all the setting items may be stored, but only the setting items which the user desires to reuse may be selected and the selected setting items and the corresponding setting values may be stored as an execution condition. Further, when the setting items for the information processing function are registered as an execution condition, information on which information processing function the execution condition is used for executing may also be stored in an execution condition.

For example, in order to use the copy function, the setting items of the copy function of a copy scale factor, one-side/both-side setting of an original to be read, and a density may be set. In this case, the copy scale factor, one-side/both-side setting, and density as the execution condition at this time may be stored as the job memory (execution condition) together with the respective setting values (parameters). At this time, information that the stored job memory (execution condition) is a setting for the copy function may be stored together.

When the user desires to use the copy function again with the similar setting later, the user may read out the stored job memory (execution condition), and may reflect the parameter for each of the setting items to the processing so as to obtain the same output using the similar parameters. In reusing the execution condition, while the stored execution condition is called to be reflected to the processing, the other setting items may be enabled to be arbitrarily set by the user in each time. Further, if a change of setting is inputted by the user after the parameters of the called setting items are once reflected, a parameter inputted newly may be reflected.

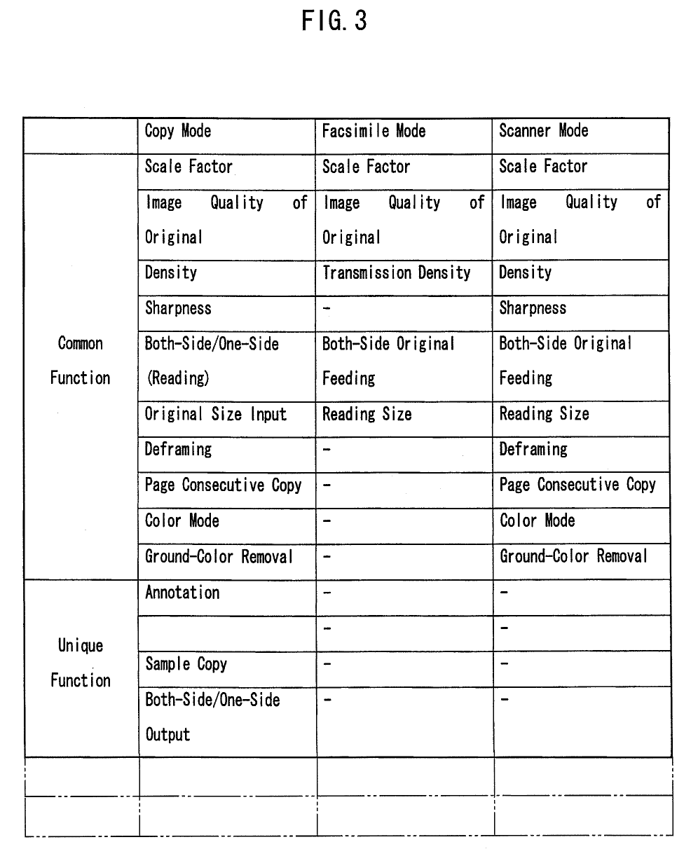

FIG. 3 shows the setting items for each of the copy mode, the facsimile mode and the scanner mode. In the copy mode and the scanner mode of the multifunction device 10, setting items such as scale factor setting, setting of image quality of an original, density setting, sharpness setting, one-side/both-side setting of an original to be read, original size input, deframing setting, page consecutive copy setting, color mode setting, and ground-color removal setting of an original can be set, and these setting items are common between these modes. Additionally in the copy mode, there are annotation setting, stapling setting, sample copy setting, both-side/one-side output setting and the like can be set as the setting items for output to a recording sheet, and parameters can be set for these items.

Moreover, in the facsimile mode of the multifunction device 10, settings of respective parameters of the setting items such as scale factor setting, setting of image quality of an original, setting of a transmission density corresponding to an original density in the copy mode, both-side original feeding setting corresponding to the one-side/both-side setting in the copy mode, and a reading size corresponding the original size in the copy mode are possible, and these setting items may be considered to be common setting items to the other mode.

In the job memory, parameters are set for the respective setting items. Once an operation for calling the registered one or more job memories is detected, the controller 30 caused the display 24 to display a list of the one or more job memories.

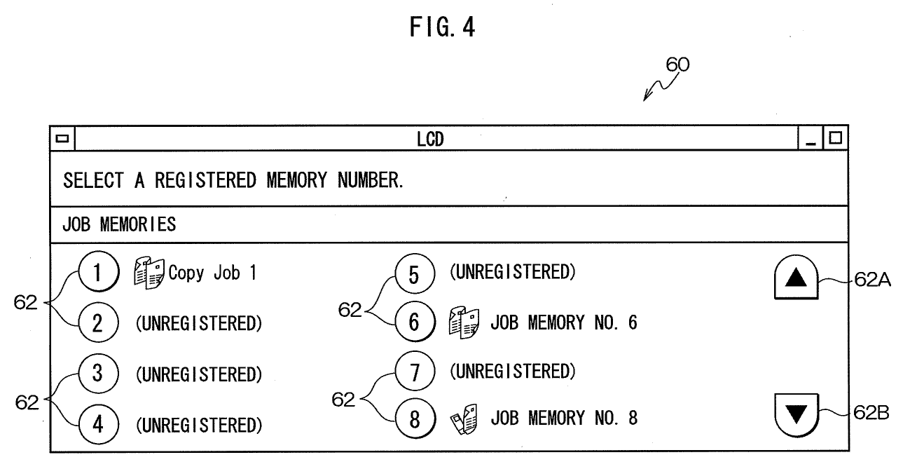

FIG. 4 shows one example of a graphical user interface (GUI) 60 that displays the job memories on the display 24. In the GUI 60, registration numbers and registration names are displayed as the list of the job memories, and by operating one of number buttons 62, the corresponding job memory is selected. When the list of the job memories extends to plural screens, a configuration in which the displayed job memories are switched by operating an up button 62A and a down button 62B, or the like can be adopted.

The function of calling the list of the job memories may be provided, for example, by displaying a software key on the display 24 of the user interface 22, or by providing a key of the hardware key 26 at the multifunction device 10. In the case where a software key displayed on the display 24 is used, a button for the list display may be displayed on a main menu, which is displayed on the display 24 and is possible to select any one of the copy mode, the scanner mode and the facsimile mode, or on a setting menu, which is displayed on the display 24 in accordance with the selected mode when any one of the copy mode, the scanner mode and the facsimile mode is selected. In the exemplary embodiment, a description is given using the hardware key 26 as an example.

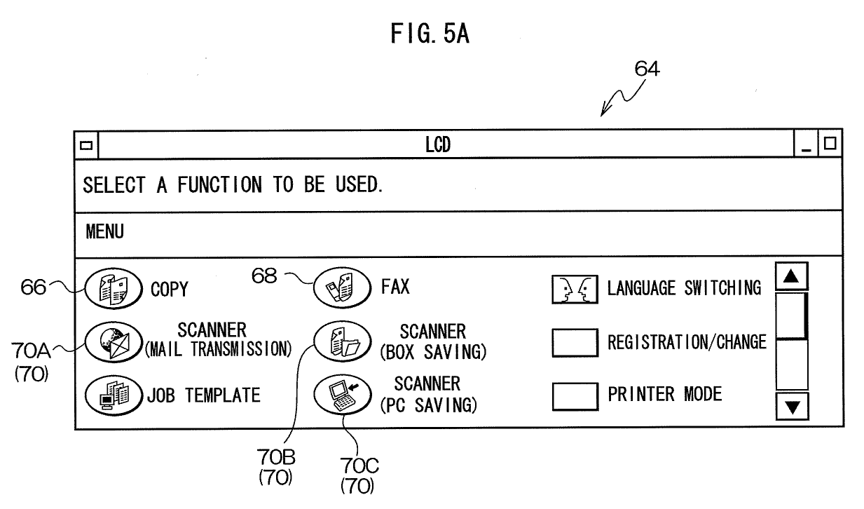

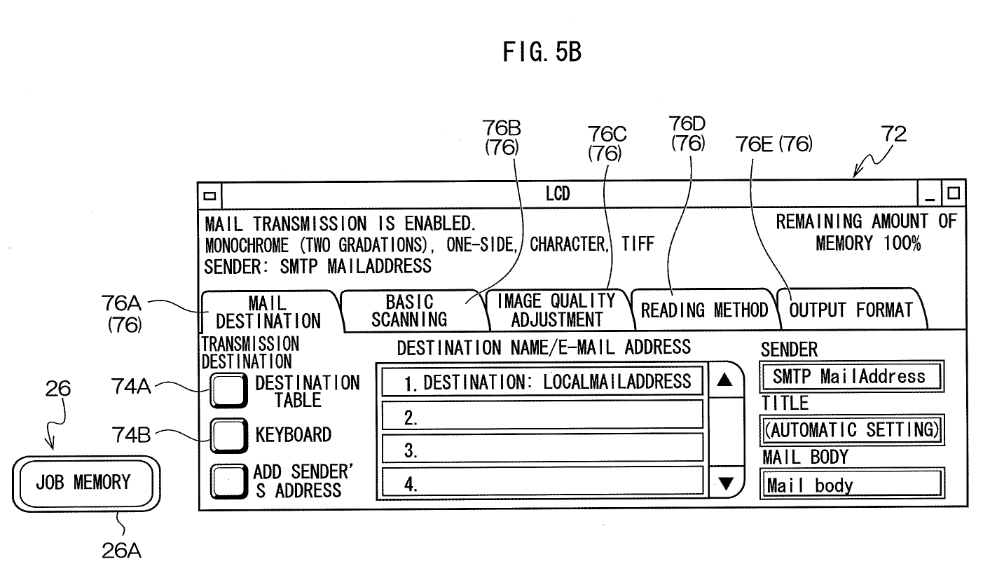

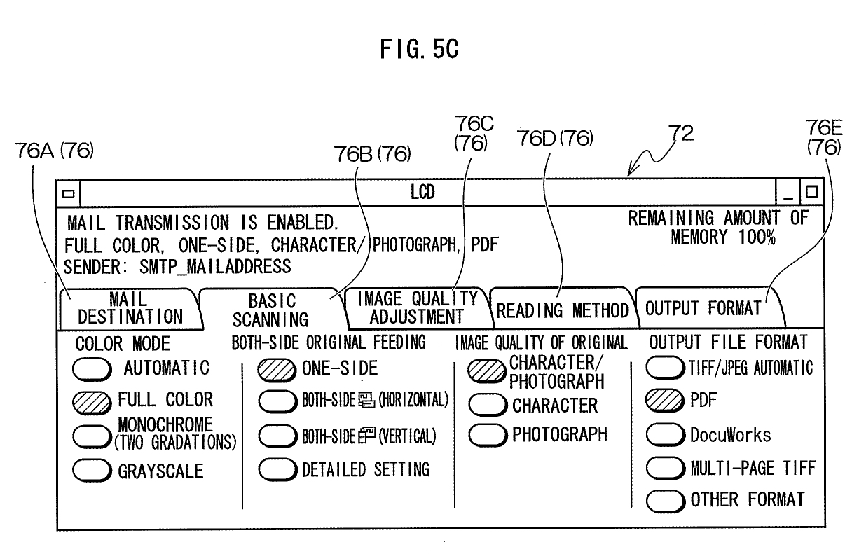

When a hardware key 26A (refer to FIG. 5B) for calling the job memories is provided in the user interface 22, for example, a GUI 64 shown in FIG. 5A may be used as the main menu displayed on the display 24.

In the GUI 64, a copy button 66 for selecting the copy mode, a fax button 68 for selecting the facsimile mode, a scanner button 70 for selecting the scanner mode and the like are displayed. In the multifunction device 10, as processing for an image of the original 20 (image data) read in the scanner mode, box saving in which the image is saved in the HDD 38 of the multifunction device 10, mail transmission in which the image is transmitted as an attached file of an e-mail to a specified image processing terminal (personal computer or the like), and PC saving in which the image is transferred to a specified image processing terminal are possible, and scanner buttons 70A, 70B, 70C are displayed as the scanner buttons 70.

FIG. 5B shows a GUI 72 as one example of display of the display 24 when the scanner button 70A is operated in the GUI 64 of FIG. 5A. In the GUI 72, input of an e-mail address as a destination name is possible. The e-mail address can be selected from a destination table, which is set and stored in advance, through an operation of a destination table button 74A, and an operation of a keyboard button 74B allows selection of input using the hardware keys 26 or a software key displayed as a pop-up menu on the display 24 for example.

Plural tabs 76 (here, tabs 76A, 76B, 76C, 76D, 76E for example) are provided in the GUI 72, and in the multifunction device 10, the setting values for the setting items displayed in the respective tabs 76 can be selected while any of the tabs 76A to 76E is being selected.

When the multifunction device 10 detects, while the GUI 72 of the FIG. 5B is displayed, that the job memory button 26A provided as the hardware key 26 has been operated, the GUI 60 (refer to FIG. 4) of the list of the registered job memories is displayed and processings using the setting values registered in the job memories in advance will be possible.

The job memory is configured to be used in a manner in which firstly specifying the information processing function (hereinafter, processing mode), and then setting the setting values of the setting items for the specified processing mode. The multifunction device 10 enables to apply the setting values of the job memory specified for a given processing mode to the setting values for a different processing mode.

For example, in the multifunction device 10, the setting values of the job memory registered for the copy mode may be deployed to be applied to the facsimile mode or the scanner mode.

As shown in FIG. 3, between the copy mode and the facsimile mode, the setting items of the scale factor setting, the setting of image quality of an original, the density setting, the both-side/one-side setting (both-side original feeding setting), and the original size input setting (reading size setting) are common. Between the copy mode and the scanner mode, the setting items of the scale factor setting, the setting of image quality of an original, the density setting, the sharpness setting, the both-side/one-side setting (both-side original feeding setting), the original size input setting (reading size setting), the deframing setting, the page consecutive copy setting, the color mode setting, and the ground-color removal setting are common.

The controller 30 provided in the multifunction device 10 performs deployment so that the setting values for the setting items which are considered to be common between the different processing modes are used in common.

Now, the image processing using the job memory in a first exemplary embodiment is described.

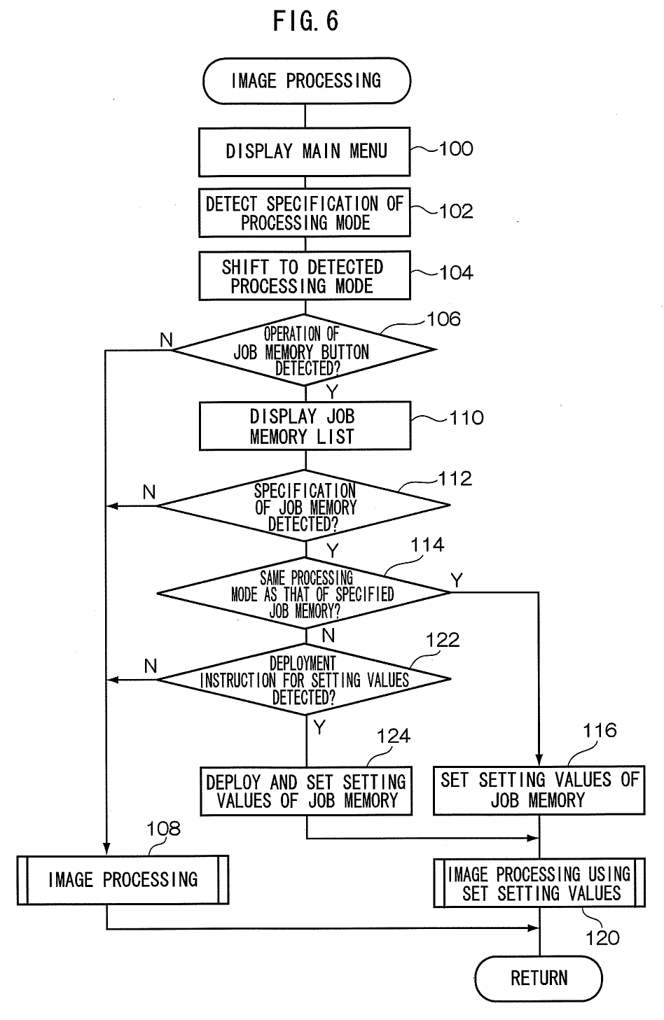

FIG. 6 shows an overview of the image processing using the job memory. The controller 30 displays the GUI 64 on the display 24 of the user interface 22 as the main menu (step 100), and upon detecting that any one of the processing modes is specified in step 102, the operation screen (e.g., GUI 72) for the specified processing mode is displayed in step 104, the processing mode shifts to the specified processing mode.

In step 106, it is determined that whether or not an operation of the job memory button 26A provided as the hardware key 26 is detected. If the operation of the job memory button 26A is not detected, a negative determination is made in step 106, and the processing proceeds to step 108. In step 108, the setting values for the respective setting items are set manually, and the image processing is performed using the set setting values.

If it is detected that the job memory button 26A is operated, an affirmative determination is made in step 106, and the processing proceeds to step 110, in which the list of the registered job memories (GUI 60) is displayed.

When the display of the job memories is selected, however, none of the job memories is specified, and cancel of the list display is performed, a negative determination is made in step 112 and the processing proceeds to step 108, in which normal image processing is executed.

In contrast, if it is detected that any one of the job memories is specified, an affirmative determination is made in step 110, and the processing proceeds to step 114. In step 114, it is determined whether or not the current processing mode and the processing mode set in the selected job memory are the same. For example, when the processing mode is shifted to the copy mode in step 104, and if the job memory set for the copy mode is specified, then an affirmative determination is made in step 114, and the processing proceeds to step 116.

In step 116, the setting values set in the job memory are directly set as the setting values for performing the image processing, and the image processing based on the set setting values is performed (step 118).

In contrast, when the current processing mode and the processing mode set for the specified job memory are different, a negative determination is made in step 114, and the processing proceeds to step 122. In step 122, a display for confirmation of whether or not the setting values (common parameters) of the common setting items in the setting items registered in the job memory should be used as the setting values for the current processing mode is displayed on the display 24, and it is determined whether or not a deployment instruction for the setting values is inputted.

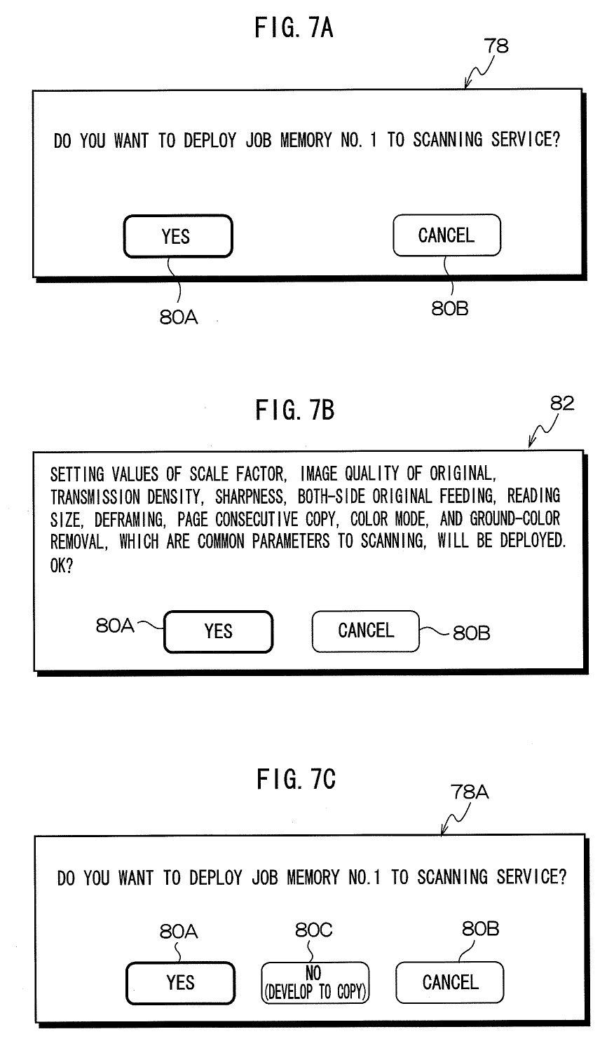

For example, when the multifunction device 10 is in the scanner mode and when the job memory of the “copy job 1” registered as No. 1 on the GUI 60 of FIG. 4 is specified, a confirmation as to whether or not the setting values of the setting items registered for the selected job memory should be used in the scanner mode is prompted. FIGS. 7A and 7B shows examples of confirmation screens displayed on the display 24 at this time are shown. These confirmation screens may be displayed as a pop-up or the like so as to overlap the job list.

In a GUI 78 shown in FIG. 7A, a message for selecting whether or not the job memory is to be deployed to the scanner mode is displayed, and a button 80A for instructing the deployment and a button 80B for canceling the deployment are displayed. In a GUI 82 shown in FIG. 7B, a message indicating the setting items to which parameters are deployed are displayed.

When it is detected that the button 80A is operated, in FIG. 6, an affirmative determination is made in step 122 and the processing proceeds to step 124. In step 124, the setting values set in the job memory are deployed as the parameters of the scanner mode, and the setting values of the setting items for the scanner mode are set.

In this way, for example, when “monochrome (two gradations)” for the color mode, “one side” for the both-side original feeding, “character” for the original image quality, and TIFF for the output file format are set as initial setting values for the scanner mode as shown in FIG. 5B, settings such as “full color” for the color mode, “one side” for both-side original feeding, “character/photograph” for the original image quality, “PDF” for the output file format and the like as shown in FIG. 5C may be set to these setting values, based on the parameters of the specified job memory.

In the flowchart of FIG. 6, the processing then proceeds to step 120, in which the processing using the set setting values is performed. In the actual processing, the parameters may be changed on the GUI 72 and used.

When an operation of the button 80B in the GUIs 78, 82 is detected, a negative determination is made in step 122 and the processing proceeds to step 108. However, the processing is not limited to this, and for example, the processing may proceed to step 110, in which the specification of a new job memory is prompted, and if no new job memory is specified, the processing proceeds to step 108. Further, as shown in FIG. 7C, a button 80C may be provided in a GUI 78A, and if it is detected that the button 80C is operated, the mode may be switched to the processing mode set in the specified job memory (here, the copy mode).

### Second Exemplary Embodiment

Next, a second exemplary embodiment will be described. In the second exemplary embodiment, configurations equivalent to those in the first exemplary embodiment are given the same reference numerals, and the descriptions are omitted.

In the first exemplary embodiment, the flow when the job memory is specified after the processing mode is specified is described. In the second exemplary embodiment, an example in which the processing mode to which the setting values of a specified job memory should be applied is specified at the time of specifying the job memory.

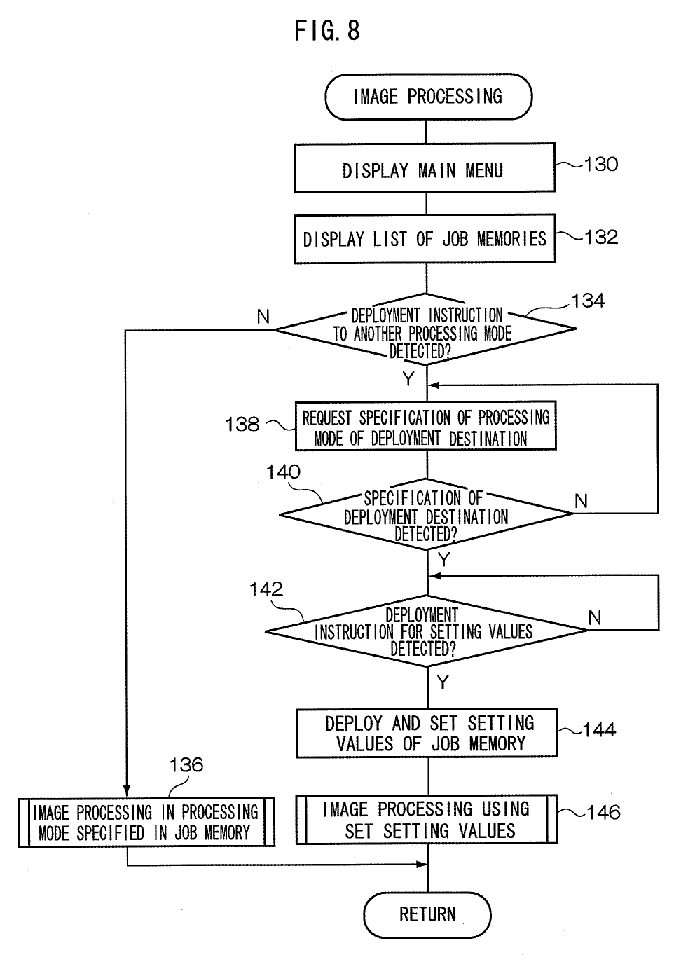

FIG. 8 shows one example of the image processing of the second exemplary embodiment. This flowchart is executed in a manner in which a menu screen for specifying a job memory is displayed in step 130 prior to the specification of the processing mode.

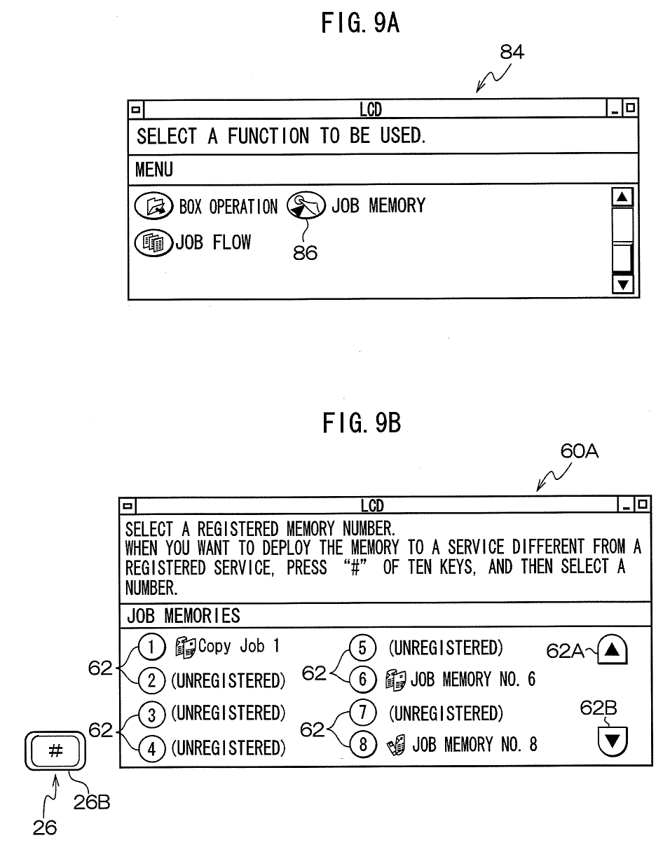

FIG. 9A shows a GUI 84 displayed on the display 24 as one example of the menu screen. In the GUI 84, a job memory button 86 is provided as a software key, and as a result of the detection of an operation of the job memory button 86 on the GUI 84, the list of the registered job memories is displayed.

In the flowchart of FIG. 8, once it is detected that the job memory button 86 has been operated, the list of the job memories is displayed in step 132.

FIG. 9B shows a GUI 60A displayed on the display 24 as one example of this job list. In the second exemplary embodiment, it is configured such that the processing mode is specified from the job memory, and in GUI 60A, a message indicating that operation is different between when specifying the processing mode set in the job memory, and when specifying a processing mode other than the processing mode set in the job memory is displayed.

In the exemplary embodiment, for example, when one of the number buttons 62 is operated to specify a job memory, the processing shifts to the processing mode set in the job memory. Further, a # key 26B provided as the hardware key 26 is used as a function key, and by specifying a job memory while operating the # key 26B, or by operating the number button 62 after operating the # key 26B, a processing mode to which the setting values set in the specified job memory is deployed can be specified.

In the flowchart of FIG. 8, whether or not an instruction to develop to another processing mode is detected is determined in step 134. If it is detected that the job memory has been specified so that the processing is performed in the processing mode registered in the job memory, a negative determination is made in step 134, and the processing proceeds to step 136. Step 136 corresponds to step 108 of FIG. 6, and the processing shifts to the processing mode registered in the specified job memory, and an image processing based on the setting values registered in the job memory can be executed.

In contrast, if an instruction to deploy the setting values of the specified job memory to another processing mode is detected, an affirmative determination is made in step 134, and the processing proceeds to step 138. In step 138, the specification of the processing mode to which the setting values are to be deployed is requested to the user.

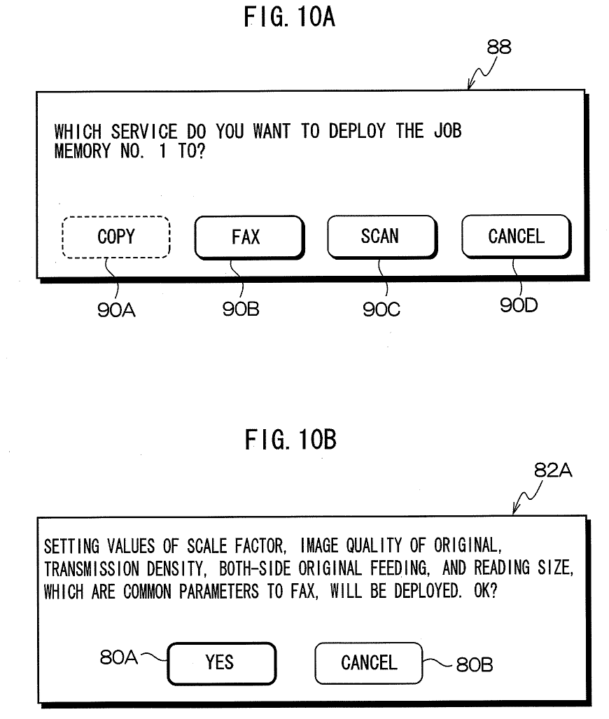

FIG. 10A shows a GUI 88 as an example of a selection screen displayed on the display 24 at this time. In FIG. 10A, it is assumed that the job memory of the copy mode, which is displayed in the GUI 60A of FIG. 9B and has been registered as No. 1, is specified.

In the GUI 88, a copy button 90A, a fax button 90B, and a scan button 90C are displayed as software keys, and in addition to these, a cancel button 90D is displayed. Since the specified job memory is that of the copy mode, in the GUI 88, the copy button 90A is disabled, and the fax button 90B and the scan button 90C are enabled and thereby a processing mode as a deployment destination can be specified. When an operation of the cancel button 90D is detected, the screen returns to the list screen (GUI 60A) of the job memories. Moreover, this GUI 88 may be displayed as a pop-up screen.

In the flowchart of FIG. 8, whether or not the specification of the processing mode has been detected is determined in step 140, and if the specification operation of the processing mode is detected, an affirmative determination is made in step 140 and the processing proceeds to step 142.

In step 142, a confirmation screen as to whether or not the setting values registered in the job memory should be deployed to the specified processing mode is displayed and it is determined whether or not a deployment instruction of the setting values (parameters) has been detected.

If the deployment instruction of the setting values is detected, an affirmative determination is made in step 142, and the processing proceeds to step 144. In step 144, among the setting values registered in the job memory, the setting values of the setting items applicable to the processing mode of the deployment destination are set as the setting values of the setting items of the processing mode of the deployment destination. That is, the setting values for the setting items of the processing mode registered in the job memory, which are common with that of the deployment destination (i.e., the common items), are deployed to the corresponding setting items of the processing mode of the deployment destination. Moreover, in step 146, the image processing in the specified processing mode is enabled. The processing in these steps 144, 146 correspond to the processing in steps 124, 120 of FIG. 6.

FIG. 10B shows a GUI 82A displayed on the display 24 as an example of a deployment confirmation screen. In the GUI 82A, the button 80A and the button 80B are displayed to enable a selection between instructing the deployment of the setting values (button 80A) and canceling the processing (button 80B). In FIG. 10B, a case where the facsimile mode is specified as the deployment destination is shown.

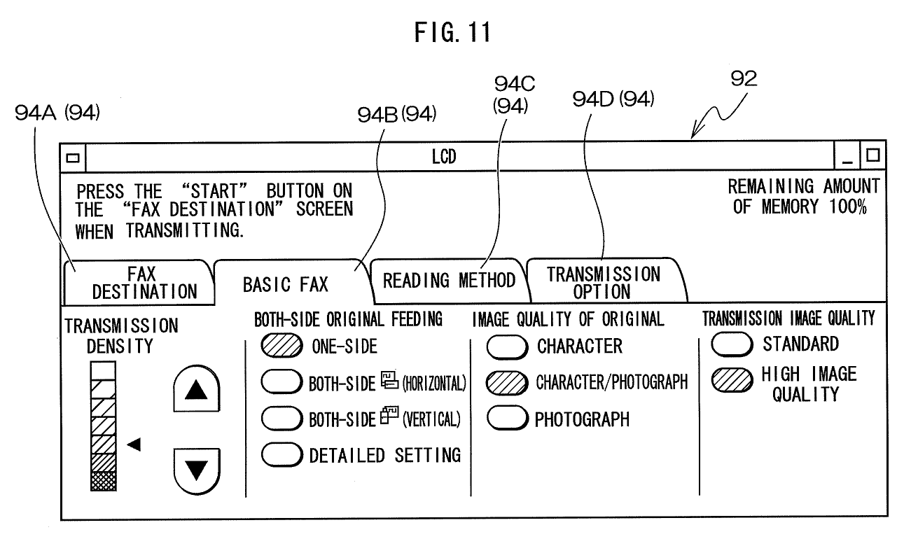

FIG. 11 shows a GUI 92, which is an operation screen of the facsimile mode as an example in which the parameters of the job memory are deployed. In the GUI 92, plural tabs 94 (here, tabs 94A, 94B, 94C, 94D) are provided, and the setting values for the setting items grouped in each of the tabs 94 can be set.

The GUI 92 shows a state in which the setting values registered in the job memory are deployed and the settings are changed from the initial values such that the transmission density setting is changed from normal (intermediate) to a little denser, the original image quality setting is changed from character to character/photograph, and the transmission image quality is changed from normal to high image quality. Note that the set setting values may be further changed on the GUI 92.

In this way, in the multifunction device 10 as the information processing apparatus, when it is detected that the job memory which is the execution condition and the processing mode which is the information processing function are specified, and when the specified processing mode and the processing mode set in the job memory are different, the setting values registered in the job memory can be deployed as the setting values of the specified processing mode and can be set as the setting values of the setting items of the specified processing mode.

The deployment of the setting values may be performed such that the setting values of the setting items of the processing mode set in the job memory, which are common with that of the specified processing mode, are set as the setting values of the corresponding setting items of the specified processing mode.

By using the setting values set in this manner, for example, saving of the image data in the scanner mode and/or transmission of the original image in the facsimile mode may be performed such that the final result will be the same as that when the original 20 is copied using the setting values of the job memory set for the copy mode.

In the multifunction device 10, by specifying a job memory to apply the setting values of the job memory to a processing mode different from the processing mode set in the job memory, the setting values registered in the job memory can be deployed to the specified processing mode.

Moreover, in the multifunction device 10, when a processing mode has been specified and the job memory for a processing mode which is different from the specified processing mode is specified in this state, the setting values of the specified job memory can be deployed to the specified processing mode.

Thus, it is possible to use the setting values of the job memory to execute a processing in the other processing mode.

In the above-described exemplary embodiments, the multifunction device 10 that forms images using the electrophotographic process is described as an example. However, embodiments are not limited to these, and may be applied to any other image processing apparatus that performs image formation using a known method.

Moreover, in the exemplary embodiments, the multifunction device 10 having the copy function, the fax communication function and the scanner function is described as an example. However, embodiments are not limited to these, and for example, may be applied to an image processing apparatus having at least two or more types of information processing functions such as the copy function and the facsimile function.

What is claimed is:

1. An image processing apparatus comprising a plurality of information processing functions, the apparatus comprising:
a storage unit that stores at least one execution condition in which a plurality of setting items set for execution of the plurality of information processing functions, and setting values for the respective setting items, are associated with one another;
a specification unit that specifies any one of the at least one execution condition;
a function specifying unit that specifies an information processing function to be executed from among the plurality of information processing functions;
a setting unit that sets the setting values of at least one setting item of the specified execution condition, which setting item can be set in the specified information processing function, as the setting values of a corresponding at least one setting item of the specified information processing function; and
an execution unit that executes the specified information processing function based on the set setting values.

2. The information processing apparatus of claim 1, wherein the storage unit further stores the at least one execution condition in association with the information processing functions corresponding to the setting items.

3. The information processing apparatus of claim 2, wherein when the specified information processing function and the information processing function associated with the specified execution condition are different, the setting unit sets at least one setting value of the specified execution condition, which is common with that of the specified information processing function, as the corresponding at least one setting value of the specified information processing function.

4. A method for operating an information processing apparatus comprising a plurality of information processing functions, the method comprising:
storing at least one execution condition in which a plurality of setting items set for execution of the plurality of information processing functions, and setting values for the respective setting items, are associated with one another;
specifying any of the at least one execution condition;
specifying an information processing function to be executed from among the plurality of information processing functions;
setting the setting values of at least one setting item of the specified execution condition, which setting item can be set in the specified information processing function, as the setting values of a corresponding at least one setting item of the specified information processing function; and
executing the specified information processing function based on the set setting values.

5. The method of claim 4, wherein the storing further comprises storing the at least one execution condition in association with the information processing functions corresponding to the setting items.

6. The method of claim 5 further comprising, when the specified information processing function and the information processing function associated with the specified execution condition are different, setting at least one setting value of the specified execution condition, which is common with that of the specified information processing function, as a corresponding at least one setting value of the specified information processing function.

7. A storage medium that stores a program that causes a computer to execute information processing, the information processing comprising:
storing at least one execution condition in which a plurality of setting items set for execution of the plurality of information processing functions, and setting values for the respective setting items, are associated with one another;
specifying any of the at least one execution condition;
specifying an information processing function to be executed from among the plurality of information processing functions;
setting the setting values of at least one setting item of the specified execution condition, which setting item can be set in the specified information processing function, as the setting values of a corresponding at least one setting item of the specified information processing function; and
executing the specified information processing function based on the set setting values.

8. The storage medium of claim 7, wherein the storing comprises storing the at least one execution condition in association with the information processing functions corresponding to the setting items.

9. The storage medium of claim 8 further comprising, when the specified information processing function and the information processing function associated with the specified execution condition are different, setting at least one setting value of the specified execution condition, which is common with that of the specified information processing function, as a corresponding at least one setting value of the specified information processing function.
